(19) United States
(12) Patent Application Publication
(10) Pub. No.: US 2019/0107163 A1
(43) Pub. Date: Apr. 11, 2019

(54) BRAKE PAD WEAR ESTIMATION

(71) Applicant: GM Global Technology Operations LLC, Detroit, MI (US)

(72) Inventors: Nojan Medinei, Toronto (CA); David B. Antanaitis, Northville, MI (US); Steven J. Weber, Mount Clemens, MI (US)

(21) Appl. No.: 15/728,850

(22) Filed: Oct. 10, 2017

(51) Int. Cl. F16D 66/02; G01L 5/22; G07C 5/08

(52) U.S. Cl. CPC F16D 66/026; G01L 5/225; G01L 5/28; G07C 5/0816; G07C 5/0808

(57) ABSTRACT

Technical solutions are described for determining thickness of a vehicle brake pad. An example method for estimating brake pad wear on a vehicle includes computing a corner torque for a brake based on corner brake pressure applied to the brake. The method also includes computing a corner power for the brake based on the corner torque. The method also includes computing a rotor temperature of a rotor of the brake based on the corner power. The method also includes determining a brake pad wear rate per unit of power based on the rotor temperature and the corner power. The method also includes computing a brake pad wear based on the brake pad wear rate and the corner power.

### INTRODUCTION

The present application relates generally to a system and method for estimating wear and, consequently, a thickness of a vehicle brake pad as it wears from use and, more particularly, to continuous blend between normal and high performance (racing) wear rates.

Braking systems across multiple types of motor vehicles, are energy conversion devices which convert mechanical energy to heat. For example, disc braking systems include a non-rotating friction material and application sub-systems, as well as a brake rotor that rotates with the wheel. To stop or slow the vehicle the friction material sub-system is engaged with the braking surfaces (rotor cheeks) of the brake rotor to generate heat due to friction, thereby converting mechanical energy to heat, and slowing the rotation of the wheel.

Vehicle brake pads typically last between 20,000 and 80,000 miles depending on the type of driving, i.e., city, highway, rural, etc., where the average brake pad life is about 50,000 miles. The thickness of the brake pad gradually decreases as a result of wear as it is used. When the thickness of the brake pad becomes sufficiently small, a mechanical scraper may make contact with the brake rotor. The mechanical scraper makes an annoying high frequency noise, which is an unfriendly reminder that the brake pad needs to be replaced. Although the noise does alert the vehicle operator that the brake pad is worn out, it does not give the vehicle operator advanced warning, or a continuous determination the lining thickness, only that the brake pad has worn down to a low level. Therefore, for example, if a long trip is planned, there is no indication that the brake pads may not last the journey.

Brake pad life monitoring has been implemented on vehicles in various ways. For example, sensors are known that include one or more wires extending across the brake pad at certain thickness levels so that when the wire breaks, the sensor will provide an indication that the brake pad thickness has been reduced a certain amount. However, such sensors are typically expensive, and do not provide a continuous indication of brake pad thickness through the life of the brake pad.

As indicated some vehicles have mechanical sensors that provide an audible sound when the brake pad wears sufficiently that the sensor contacts the brake rotor. Some vehicles have an electronic sensor that provides a one-time signal when brake pad wear reaches a predetermined amount of wear, and may indicate this to a vehicle operator as a percentage remaining brake pad life in a vehicle information center accessible on the dash board or steering wheel. A more advanced wear life algorithm estimates brake pad wear based on an estimated rotor temperature correlated with typical driving conditions requiring relatively low braking energy.

Some vehicle owners occasionally or routinely exhibit aggressive, high energy braking behavior either on public roads or during racetrack maneuvering. Racetrack operation of a vehicle requires attention to brake pad wear, as brake pads may tend to wear more quickly under the relatively high speed maneuvering. Also, due to different loading conditions, uneven side-to-side brake pad wear on each axle is normally seen during aggressive racetrack maneuvering. Visually inspecting brake pads during racetrack sessions is inconvenient as “pit stop” time is extended.

### SUMMARY

Exemplary embodiments of a method for determining thickness of a vehicle brake pad are described. An example method for estimating brake pad wear on a vehicle includes computing a corner torque for a brake based on corner brake pressure applied to the brake. The method also includes computing a corner power for the brake based on the corner torque. The method also includes computing a rotor temperature of a rotor of the brake based on the corner power. The method also includes determining a brake pad wear rate per unit of power based on the rotor temperature and the corner power. The method also includes computing a brake pad wear based on the brake pad wear rate and the corner power.

In one or more examples, the method further includes accumulating the brake pad wear to provide an estimation of thickness of the brake pad. Further, the method further includes notifying of the brake pad thickness estimation using telematics.

In one or more examples, the corner torque is computed based on the corner brake pressure, and a friction coefficient of the brake rotor.

In one or more examples, the method further includes computing the friction coefficient of the brake rotor based on braking speed, the rotor temperature, and corner energy. In one or more examples, the friction coefficient is computed based on linear interpolation using preselected values of the braking speed, the rotor temperature, and the corner energy. In one or more examples, the friction coefficient is computed based on non-linear interpolation using preselected values of the braking speed, the rotor temperature, and the corner energy. In one or more examples, the friction coefficient is computed based on neural networks using preselected values of the braking speed, the rotor temperature, and the corner energy.

According to one or more embodiments a vehicle brake system for determining brake pad thickness of a brake pad, includes a brake rotor, the brake pad and a processor. The processor receives vehicle parameters that identify operating conditions of a vehicle. The processor also computes a corner torque based on corner brake pressure applied to the vehicle brake system. The processor further computes a corner power for the vehicle brake system based on the corner torque. The processor further computes a rotor temperature of the rotor based on the corner power. The processor further determines a brake pad wear rate per unit of power based on the rotor temperature and the corner power. The processor further computes a brake pad wear based on the brake pad wear rate and the corner power.

In one or more examples, the processor further accumulates the brake pad wear to provide an estimation of the thickness of the brake pad. In one or more examples, the processor further notifies the brake pad thickness estimation using telematics.

In one or more examples, the vehicle parameters include brake rotor friction material, brake rotor cooling rate, dynamic brake proportioning, vehicle speed, wheel speed and brake pressure applied by master brake cylinder.

In one or more examples, the corner torque is computed based on the corner brake pressure, and a friction coefficient of the brake rotor, where the processor computes the friction coefficient of the brake rotor based on braking speed, the rotor temperature, and corner energy. In one or more examples, the friction coefficient is computed based on interpolation using preselected values of the braking speed, the rotor temperature, and the corner energy. In one or more examples, the friction coefficient is computed using preselected values of the braking speed, the rotor temperature, and the corner energy.

According to one or more embodiments a computer program product including non-transitory computer readable medium having computer executable instructions, where the computer executable instructions cause a processing unit to determine thickness of a vehicle brake pad by computing a corner torque for a brake based on corner brake pressure applied to the brake. Further, the processing unit computes a corner power for the brake based on the corner torque, and a rotor temperature of a rotor of the brake based on the corner power. Further, the processing unit determines a brake pad wear rate per unit of energy based on the rotor temperature and the corner power. Further, the processing unit computes a brake pad wear based on the brake pad wear rate and the corner energy.

In one or more examples, the computer executable instructions cause the processing unit to accumulate the brake pad wear to provide an estimation of the thickness of the brake pad.

In one or more examples, the corner torque is computed based on the corner brake pressure, and a friction coefficient of the brake rotor, where the processing unit further computes the friction coefficient of the brake rotor based on braking speed, the rotor temperature, and corner energy.

In one or more examples, the friction coefficient is computed based on interpolation using preselected values of the braking speed, the rotor temperature, and the corner energy. Alternatively, in one or more examples, the friction coefficient is computed using preselected values of the braking speed, the rotor temperature, and the corner energy.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts example components of a vehicle according to one or more embodiments;

FIG. 2 is a block diagram of a brake pad thickness estimation system, according to one or more embodiments;

FIG. 3 depicts a flowchart of an example method for estimating brake pad thickness, according to one or more embodiments; and

FIG. 4 depicts a flowchart of an example method for notifying a vehicle operator of the estimated brake pad thickness according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

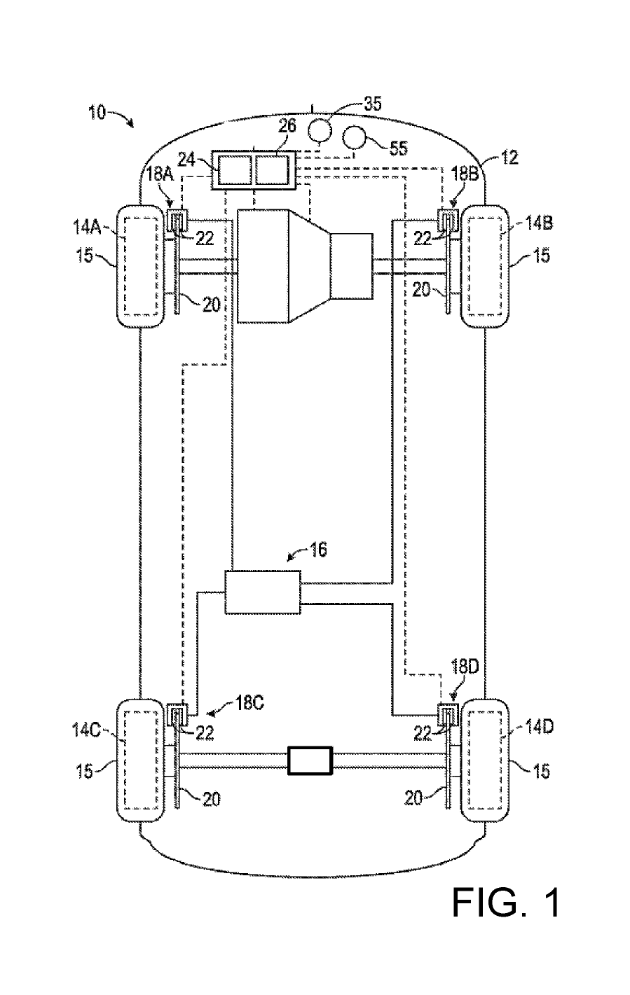

FIG. 1 shows a vehicle 10 that has a vehicle body 12 that is operatively connected to rotatable wheels 14A, 14B, 14C, 14D for moving the vehicle body 12 when propelled by an engine via a transmission. In one non-limiting example, the vehicle 10 is a front wheel-drive vehicle. A differential operatively connects the front wheels 14A, 14B, and a differential operatively connects the rear wheels 14C, 14D via half shafts as is known. Tires 15 are shown mounted on the wheels 14A, 14B, 14C, 14D. The vehicle 10 includes a braking system 16 that is configured to stop rotation of the wheels 14A, 14B, 14C, 14D. The braking system 16 includes a fluid pressure source in communication with respective braking mechanism 18A, 18B, 18C, 18D operatively connected with each respective wheel 14A, 14B, 14C, 14D. The braking mechanisms 18A, 18B, 18C, 18D each have a brake rotor 20 rotatable with the respective wheel 14A, 14B, 14C, 14D, and respective brake pads 22 placed in contact with opposite sides of the brake rotor 20 during braking.

An electronic controller has a processor 24 that executes a stored algorithm 26 for determining brake pad wear and, accordingly, predicts remaining life of the brake pads 22, by accurately modeling wear even when the vehicle 10 is operated under relatively extreme driving, such as relatively high energy braking conditions. Additionally, the algorithm 26 operates in (a similar manner in) high energy braking conditions, and in typical driving with associated lower energy braking conditions. The technical solutions described herein facilitate using sensor information, driver braking information and driver brake models to predict or estimate brake pad thickness, and provide an indication of remaining brake pad life, such as in remaining miles or percentage of brake pad thickness, to the vehicle operator. As will be discussed in detail below, the brake pad thickness estimation algorithm uses various parameters and sensor signals to provide the estimation, including, but not limited to, brake rotor material properties, brake rotor cooling rate, brake temperature, vehicle mass, road grade, dynamic brake proportioning, vehicle weight distribution, brake pressure applied, braking energy, braking power, etc.

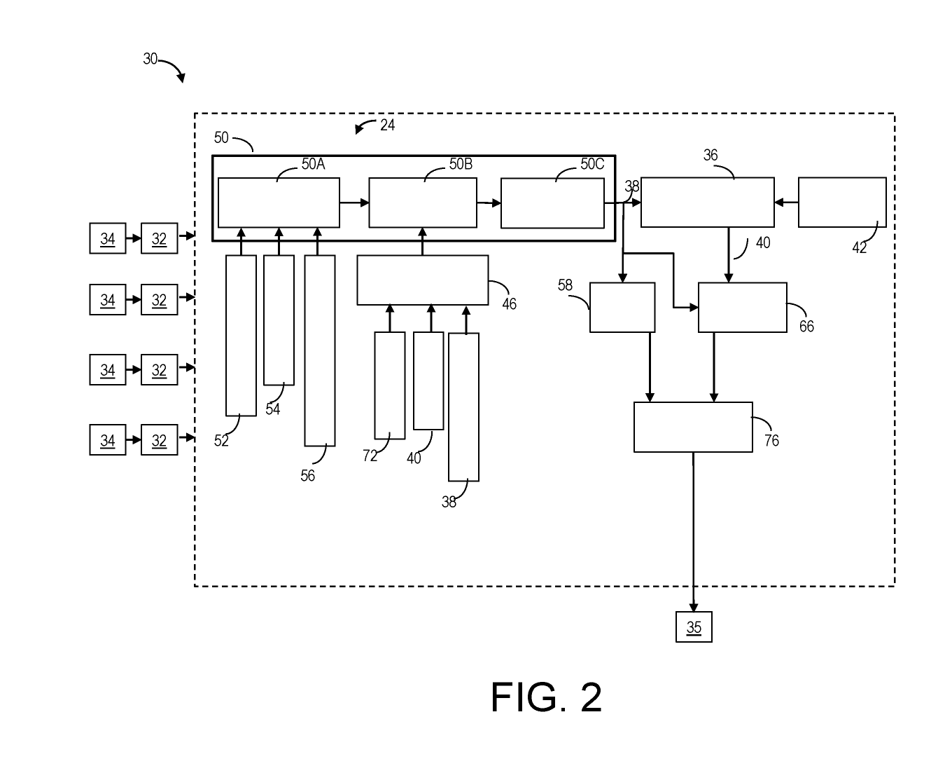

Referring to FIG. 2, a system 30 for estimating brake pad wear on the vehicle 10 includes various vehicle sensors 32, and includes the controller that receives input signals from the sensors 32 so that the processor 24 can carry out the stored algorithm 26, represented as various modules each modeling aspects of the vehicle operation based on the sensor inputs, to produce a wear signal in a brake pad wear indicator output device 35, such as an operator display device or an audio signal. Although only four sensors 32 are depicted, many more sensors may be included in the system 30. The sensors 32 may include wheel speed sensors, brake pressure sensors, and other sensors and the input from the sensors 32 may include brake pressure, wheel speeds, vehicle speed, longitudinal acceleration, dynamic brake proportioning, brake apply. Various systems 34 may provide input signals, including vehicle systems and off-board systems, such as telematics systems, global positioning systems, map information. The input from the sensors 32 and systems 34, may be used by the controller to estimate or calculate vehicle mass, road grade, amount of engine braking, braking energy, rolling resistance, appropriate rotor cooling coefficients, lateral and longitudinal acceleration, and other vehicle operating characteristics as described herein. It should be noted that one or more of these estimated values may be used by the technical solutions described herein.

It should be appreciated that the electronic controller may be configured as a single or distributed control device that is electrically connected to or otherwise placed in hard-wired or wireless communication with the engine E, the transmission T, the braking system 16, and various vehicle components, including sensors, for transmitting and receiving electrical signals for proper execution of the algorithm 26.

The electronic controller includes one or more control modules, with one or more processors 24 and tangible, non-transitory memory, e.g., read-only memory (ROM), whether optical, magnetic, flash, or otherwise. The electronic controller C may also include sufficient amounts of random access memory (RAM), electrically-erasable programmable read-only memory (EEPROM), and the like, as well as a high-speed clock, analog-to-digital (A/D) and digital-to-analog (D/A) circuitry, and input/output circuitry and devices (I/O), as well as appropriate signal conditioning and buffer circuitry.

The electronic controller can be a host machine or distributed system, e.g., a computer such as a digital computer or microcomputer, acting as a vehicle control module, and/or as a proportional-integral-derivative (PID) controller device having a processor, and, as the memory, tangible, non-transitory computer-readable memory such as read-only memory (ROM) or flash memory. Therefore, the controller can include all software, hardware, memory, algorithms, connections, sensors, etc., necessary to monitor the vehicle 10 and control the system 30. As such, one or more control methods executed by the controller can be embodied as software or firmware associated with the controller. It is to be appreciated that the controller can also include any device capable of analyzing data from various sensors, comparing data, and making decisions required to monitor brake pad wear and alert the vehicle operator of brake pad life. Moreover, the electronic controller can be configured in different embodiments to include a brake controller, a powertrain controller, and other controllers onboard or off-board the vehicle 10.

The algorithm 26 includes determining rotor temperature according to a standard rotor temperature model 36. The standard rotor temperature model 36 utilizes a calculation of braking energy 38 and a set of cooling coefficients 42 for a thermal temperature model of the brake pads 22 and/or rotors. The calculated braking energy 38 and cooling coefficients 42 are appropriate (i.e., substantially accurate) for vehicle operating conditions. Accordingly, the rotor temperature model 36 utilizes a calculated braking energy 38 and an equation for heat transfer from each rotor 20 that utilizes cooling coefficients 42 selected to correlate with the driving conditions.

The cooling rate of the rotors 20 when they are not in use helps determine the brake pad temperature, and is dependent on the mass of the rotor 20, vehicle design, vehicle speed, wheel speed, ambient temperature, altitude, etc. As the vehicle 10 moves, the air flowing around each rotor 20 will determine how fast it is cooled from the previous braking event. The cooling coefficients 42 used in the lumped capacitance model of temperature decay (Equation 1) are selected to be correlated with rotor temperature, vehicle speed, and braking energy.

In one or more examples, the lumped capacitance model for brake rotor cooling is as follows:

$$\begin{matrix}\frac{d T}{dt} = - b ( T - {T}_{a} ) + D ( 1 ) ; & ( 1 ) \\ D = \frac{{P}_{d}}{ρ {V}_{c}} & ( 2 )\end{matrix}$$

where P_{d} is brake residual drag, ρ is the density of the rotor material, V is the volume of the rotor material, and c is the specific heat capacity of the rotor material. The term b is the “cooling coefficient” and is calculated as:

$$\frac{h A}{ρ {V}_{c}} \qquad ( 3 )$$

where h is the convective heat transfer coefficient and A is the working area (exposed to convective cooling airflow).

Cooling coefficients are measured in vehicle tests by recording the cooling rate of the brake rotors and fitting the lumped capacitance model to the recorded data. Cooling coefficients vary approximately linearly with vehicle speed. Cooling coefficients may be measured at discrete speeds, and may then a linear model may be fit to the data to determine cooling coefficients at any speed. Typical cooling coefficient values vary by brake rotor design and vehicle environment. An example cooling coefficient versus vehicle speed relationship is:

b=0.00033V+0.0033 (4)

where V is the vehicle forward velocity in kilometers per hour.

The calculated braking energy 38 used in the rotor temperature model 36 is an estimate of the braking energy dissipation in the braking mechanisms 18A, 18B, 18C, 18D. In one or more examples, a braking energy module 50 computes the input energy (Eᵢₙ) at each corner. This calculation uses various inputs, such as stopping distance, stopping time, brake pad temperature, etc. The master cylinder pressure 52 of the braking system 16, the weight distribution in the vehicle 10 and the dynamic brake proportioning for the proportional brake pressure at each wheel 14A-14D are used to determine corner brake pressure (Pᵢ) by a corner brake pressure sub-module 50A. The corner brake pressure sub-module 50A further receives as inputs ABS control signals 54, and brake actuator control model 56 to determine the corner brake pressure. In one or more examples, ABS control signal 54 indicates whether an ABS valve is turned on to reduce applied pressure in a specific corner, based on the slipping conditions of the wheel. For example, the ABS control signal 54 determines the control mode of ABS valves, ON or OFF. The brake actuator control model 56 uses known transfer functions relating the master cylinder pressure to individual corner pressures.

Computing the braking energy further includes a corner torque module 50B computing a corner torque (Tᵢ) based on the corner brake pressure (Pᵢ) and a friction coefficient (μ) of the brake pad 22. For example:

Braking Force=pressure×area×μ

where, area is the surface area of the brake pad 22.

Further, a friction coefficient module 46 estimates the friction coefficient (μ) of the brake rotor. For example, brake rotor dynamometer tests can be used to obtain the friction coefficient as a function of temperature, braking speed, and input braking energy. The tests are used to determine the amount of wear expected at different combinations of rotor temperature, braking speed, and input braking energy, and the thermal model is configured accordingly. Further, the friction coefficient is estimated at each corner based on vehicle braking speed (V) 72, temperature (T) 40 estimate, and input braking power (Eᵢₙ) 38. For example, the calculated braking energy 38 and temperature 40 from the temperature model 36 are fed into the friction coefficient module 46 along with a vehicle braking speed signal 72.

In one or more examples, the friction coefficient module 46 estimates the friction coefficient using linear interpolation based on a predetermined sample values. For example, the friction coefficient module 46 uses multivariate linear interpolation, such as trilinear interpolation, using the sample values include friction coefficient values observed for a set of temperature, braking speed, and braking energy values.

Alternatively, in one or more examples, the friction coefficient module 46 estimates the friction coefficient using non-linear interpolation based on the predetermined sample values of temperature, braking speed, and braking energy values. For example, the friction coefficient module 46 uses cubic, sinusoidal, cosine, parabolic, or other functions for interpolating between the sample values observed for a set of temperature, braking speed, and braking energy values to determine the friction coefficient for the input values of the temperature, braking speed, and braking energy.

Alternatively, in one or more examples, the friction coefficient module 46 estimates the friction coefficient using machine learning algorithms, such as artificial neural networks, based on the predetermined sample values of temperature, braking speed, and braking energy values. For example, the neural network may be taught using backpropagation technique to learn the appropriate friction coefficient associated with a set of temperature, braking speed, and braking energy values. This learning procedure uses data results from a physical dyno test.

Further, the corner torque module 50B computes the torque for both the front and the rear of the vehicle 10 and is a function of the brake pressure and the dynamic brake proportioning. For example, based on a rolling radius (RR) of the wheel 14A, 14B, 14C, or 14D, and the vehicle velocity (V) 72:

τ_{brake}=2·p_{fluid}·Aₚᵢₛₜₒₙ·nₚᵢₛₜₒₙ·μ_{fric}·r_{eff}

where, p_{fluid} is the applied brake pressure of the hydraulic system on the brake piston; Aₚᵢₛₜₒₙ is the effective area of brake piston; nₚᵢₛₜₒₙ is the number of caliper pistons; μ_{fric} is the friction coefficient between the brake pad material and rotor; and r_{eff} is the effective radius.

The front/rear brake proportioning information and the cornering information available from the brake controller C is used by a corner power module 50C to determine the power distribution on each axis and corner. For example, power (Pin) dissipated through braking at each corner is calculated by multiplying the wheel angular speed (ω) and the calculated torque (τbrake) at each corner: Pin=τbrake× ω. By computing dissipated braking power at individual corners, the method captures corner-to-corner difference in brake pad wear due to racetrack maneuvering conditions.

In one or more examples, the corner torque is input into the thermal model 36 for first order dynamics to determine the estimate of the brake temperature (T) 40. An integration module 58 computes the energy input to the brake pad by computing an integration/summation of the applied corner braking energy 38.

A wear rate module 66 receives the estimated temperature T 40, and the corner power Pin to determine a wear rate wear based on the input parameters. For example, the wear rate is a rate of volumetric wear of the brake pads 22 per mega Joules of input energy. It should be noted that other units may be used in other examples.

For example, one or more look-up tables in the estimation processor facilitate determining the wear rate value based on the temperature and input power values. The look-up table(s) are populated based on the relationship between the braking energy and the brake temperature and the brake temperature and the brake pad wear based on the calculations discussed above and the properties of the brake pads 22.

The wear rate is further provided to a wear estimation module 76. The wear estimation module 76 further receives the total input power (Ein), which when multiplied by the wear rate outputs the wear experienced by the brake pads 22. Each time the system calculates the wear of the brake pads 22, it is added to the previous calculations of wear over time, and can then be extrapolated from the vehicle mileage to determine the remaining mileage for each brake pads 22. Thus, the controller C facilitates determining wear rate and further computing the brake pad wear by using 3D look-up table of volumetric wear rate vs. temperature and input power. Alternatively, or in addition, instead of using look-up tables, in one or more examples, the controller C determines the brake pad wear dynamically using a predetermined computation formula that is based on the relationship between the braking energy and the brake temperature and the brake temperature and the brake pad wear.

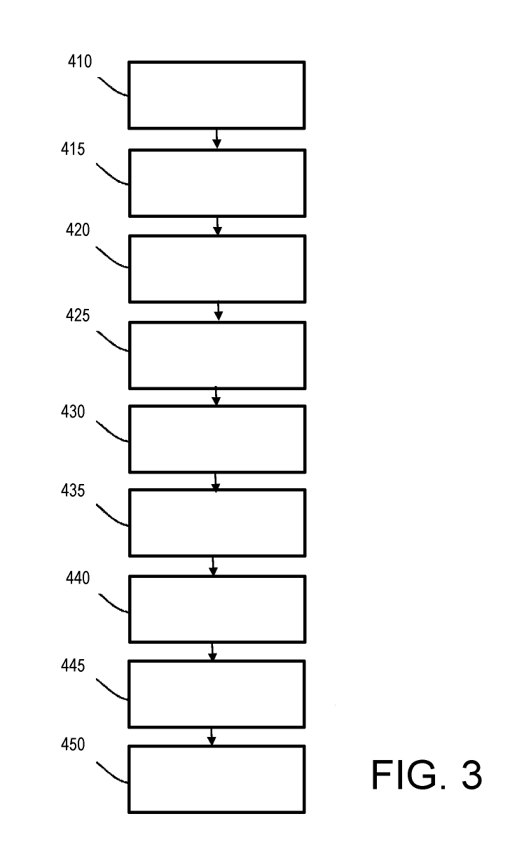

FIG. 3 depicts a flowchart of an example method for estimating brake pad thickness, according to one or more embodiments. The method includes receiving and collecting various vehicle signals, such as brake pressure, wheel speeds, vehicle speed, longitudinal acceleration, dynamic brake proportioning, brake being applied, etc., as shown at 410. The method further includes obtaining system estimates from the power train controller 14, such as the vehicle mass, road grade, amount of engine braking, rolling resistance, rotor surface area etc., as shown at 415. The method further includes obtaining system estimates from the brake controller, such as the brake temperature, as shown at 420. The method further includes computing the brake work from braking energy, as shown at 425. For example, the braking energy is computed as per the computations described herein. The braking energy can be calculated for any one of the several brake pads 22 on the vehicle 10 or can be one calculation per vehicle axle.

Additionally, or alternately, the method includes determining the brake work using braking power as shown at 430. In this calculation, the brake work is determined by braking torque and pressure, such as described herein. Computing the brake torque further includes computing a friction coefficient estimate based on the brake temperature estimate, input braking energy, and vehicle speed. Further, the braking power is computed based on the torque and a wheel angular speed.

The method further includes determining the brake temperature, as shown at 435, and determining the brake pad wear, as shown at 440 in the manner discussed above. Determining the brake pad wear, at 440, includes determining the volumetric wear rate based on the temperature estimate and the input braking power to the braking mechanisms 18A-D. The brake pad wear is determined for each braking event, and is added to the accumulated value, as shown at 445 to determine the remaining brake pad thickness/cumulative brake pad wear. The method includes sending the estimated thickness information to the vehicle operator using, for example, vehicle telematics, as shown at 450.

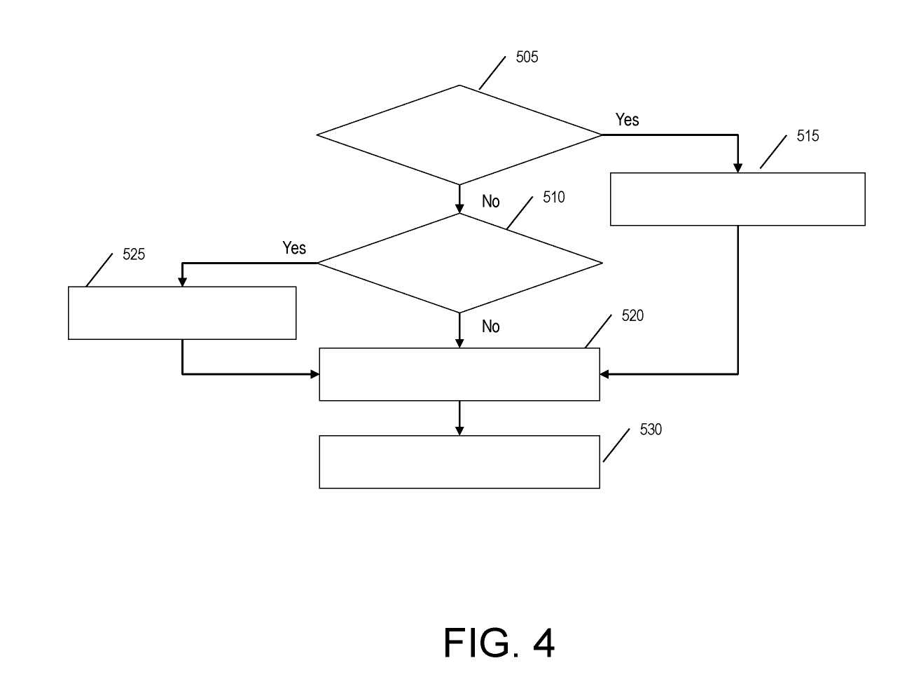

FIG. 4 depicts a flowchart of an example method for notifying the vehicle operator of the estimated brake pad thickness according to one or more embodiments. The method includes determining whether the wear level of the brake pads 22 is greater than a first predetermined threshold, as shown at 505. The pad thickness is determined based on the process discussed herein. The first predetermined threshold is a predetermined value at which replacing the brake pads 22 is recommended. For example, the replacement threshold may be a proportional value, such as 30% of original thickness of the brake pads, or an absolute value, such as 2 mm. It should be noted that the above values are examples, and that different embodiments may use different threshold values than those above.

If the replacement threshold is reached, the vehicle operator is notified to replace the brake pads 22, as shown at 515. If the brake pad thickness has not reached the replacement threshold, the method includes determining if the brake pad thickness has reached a second predetermined threshold, as shown at 510. The second predetermined threshold may be a predetermined value that is representative of an inspection threshold. For example, the replacement threshold may be a proportional value, such as 50% of original thickness of the brake pads 22, or an absolute value, such as 1.5 mm, 2 mm, or the like. It should be noted that the above values are examples, and that different embodiments may use different threshold values than those above. If the inspection threshold is reached, the vehicle operator is indicated to have the brake pads 22 inspected, as shown at 525.

In one or more examples, regardless of the relation between the brake pad thickness and the threshold values, the vehicle operator is informed of the current estimated brake pad thickness, as shown at 520. Further, the method includes determining a life of the brake pad left based on the estimated wear of the brake pads 22, as shown at 530. For example, the life of the brake pad may be measured in terms of an estimated number of miles that the brake pad can be used before the replacement threshold is reached. For example, the method includes informing the vehicle operator in miles using a linear interpolation based on vehicle operation to date as to the remaining life of the brake pads 22, as shown at 530. The method thus facilitates the vehicle operator to be notified in any suitable manner, and can be informed of the miles remaining based on the current wear of the brake pads 22 as to when the brake pads 22 need to be replaced.

In one or more examples, the vehicle 10 is an autonomous vehicle with the vehicle operator being a processor unit. In such cases, the processor unit receives the estimated brake pad thickness and/or the remaining brake pad life estimate. Based on such input, the vehicle operator processor unit automatically drives the vehicle 10 to a service station. For example, if the brake pad thickness falls below the inspection threshold, the processor unit causes the vehicle 10 to be driven to the service station for the brake pad inspection. Alternatively, or in addition, if the brake pad thickness falls below the replacement threshold, the processor unit causes the vehicle 10 to be driven to the service station for the brake pad replacement. Other automatic actions may also be performed in response to the brake pad thickness comparison, such as scheduling servicing of the vehicle.

It should be noted that although the examples so far describe computing the pad thickness and using the computed thickness to determine the life of a pad, in one or more examples, the pad thickness of all the brake pads equipped in the vehicle are analyzed. Accordingly, the vehicle operator is informed of the pad thickness and pad life estimated for each brake assembly that is installed on the vehicle.

The technical solutions described herein facilitate predicting wear for a brake pad of a brake system based on corner pressure calculation using ABS controls and brake actuator model, and an estimation of friction coefficient. The technical solutions, in one or more examples, use 3D look-up tables of track wear rates to determine pad wear estimation. The technical solutions provide a robust solution for estimating the pad wear across various uses of the vehicle, such as normal use, high-performance use such as racing, and thus avoids switching from normal to race track conditions, which in turn continuously monitors corner pressures and predicting rotor temperatures and wear rates.

The technical solutions predict brake pad wear over a wide range of vehicle use and generate an electronic pad wear/pad remaining life signal. The pad wear and/or life remaining may be displayed to the vehicle operator and/or used in various control algorithms that are implemented by one or more electronic control units (ECU) in the vehicle.

The technical solutions can save a vehicle owner from costly repairs resulting from excessive wear of a brake pad. The technical solutions can further help owners of fleets (such as autonomous vehicle fleets) monitor brake pad life to plan when to service vehicles.

The technical solutions facilitate the prediction of the brake pad life without introducing additional costs by utilizing existing brake pad wear sensors (BPWS) for correction purposes. Further, because the prediction is robust irrespective of the use (normal/high performance), the technical solution offers track-capable brake-pad life monitoring (BPLM) technology.

The present technical solutions may be a system, a method, and/or a computer program product at any possible technical detail level of integration. The computer program product may include a computer readable storage medium (or media) having computer readable program instructions thereon for causing a processor to carry out aspects of the present technical solutions.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technical solutions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present technical solutions.

Aspects of the present technical solutions are described herein with reference to flowchart illustrations and/or block diagrams of methods, apparatus (systems), and computer program products according to embodiments of the technical solutions. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present technical solutions. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are to be construed in the broadest sense, superseding any other implied definitions hereinbefore or hereinafter unless expressly asserted to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

It will also be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Such computer storage media may be part of the device or accessible or connectable thereto. Any application or module herein described may be implemented using computer readable/executable instructions that may be stored or otherwise held by such computer readable media.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for estimating brake pad wear on a vehicle, the method comprising:
computing a corner torque for a brake based on corner brake pressure applied to the brake;
computing a corner power for the brake based on the corner torque;
computing a rotor temperature of a rotor of the brake based on the corner power;
determining a brake pad wear rate per unit of power based on the rotor temperature and the corner power; and
computing a brake pad wear based on the brake pad wear rate and the corner power.

2. The method of claim 1, further comprising:
accumulating the brake pad wear to provide an estimation of thickness of the brake pad.

3. The method of claim 1, wherein the corner torque is computed based on the corner brake pressure, and a friction coefficient of the brake rotor.

4. The method of claim 3, further comprising computing the friction coefficient of the brake rotor based on braking speed, the rotor temperature, and corner energy.

5. The method of claim 4, wherein the friction coefficient is computed based on linear interpolation using preselected values of the braking speed, the rotor temperature, and the corner energy.

6. The method of claim 4, wherein the friction coefficient is computed based on non-linear interpolation using preselected values of the braking speed, the rotor temperature, and the corner energy.

7. The method of claim 4, wherein the friction coefficient is computed based on neural networks using preselected values of the braking speed, the rotor temperature, and the corner energy.

8. The method of claim 2, further comprising notifying of the brake pad thickness estimation using telematics.

9. A vehicle brake system for determining brake pad thickness of a brake pad, the system comprising:
a brake rotor;
the brake pad; and
a processor configured to:
receive vehicle parameters that identify operating conditions of a vehicle;
compute a corner torque based on corner brake pressure applied to the vehicle brake system;
compute a corner power for the vehicle brake system based on the corner torque;
compute a rotor temperature of the rotor based on the corner power;
determine a brake pad wear rate per unit of power based on the rotor temperature and the corner power; and
compute a brake pad wear based on the brake pad wear rate and the corner power.

10. The vehicle brake system of claim 9, wherein the processor is further configured to accumulate the brake pad wear to provide an estimation of the thickness of the brake pad.

11. The vehicle brake system of claim 10, the processor further configured to notify the brake pad thickness estimation using telematics.

12. The vehicle brake system of claim 9, wherein the vehicle parameters comprise brake rotor friction material, brake rotor cooling rate, dynamic brake proportioning, ABS controls, vehicle speed, wheel speed and brake pressure applied by a master brake cylinder.

13. The vehicle brake system of claim 9, wherein the corner torque is computed based on the corner brake pressure, and a friction coefficient of the brake rotor, wherein the processor is further configured to compute the friction coefficient of the brake rotor based on braking speed, the rotor temperature, and corner energy.

14. The vehicle brake system of claim 13, wherein the friction coefficient is computed based on interpolation using preselected values of the braking speed, the rotor temperature, and the corner energy.

15. The vehicle brake system of claim 13, wherein the friction coefficient is computed using preselected values of the braking speed, the rotor temperature, and the corner energy.

16. A computer program product comprising non-transitory computer readable medium having computer executable instructions, the computer executable instructions causing a processing unit to determine thickness of a vehicle brake pad by:
computing a corner torque for a brake based on corner brake pressure applied to the brake;
computing a corner power for the brake based on the corner torque;
computing a rotor temperature of a rotor of the brake based on the corner power;
determining a brake pad wear rate per unit of energy based on the rotor temperature and the corner power; and
computing a brake pad wear based on the brake pad wear rate and the corner energy.

17. The computer program product of claim 16, wherein the computer executable instructions cause the processing unit to: accumulate the brake pad wear to provide an estimation of the thickness of the brake pad.

18. The computer program product of claim 17, wherein the corner torque is computed based on the corner brake pressure, and a friction coefficient of the brake rotor, wherein the processing unit further computes the friction coefficient of the brake rotor based on braking speed, the rotor temperature, and corner energy.

19. The computer program product of claim 18, wherein the friction coefficient is computed based on interpolation using preselected values of the braking speed, the rotor temperature, and the corner energy.

20. The computer program product of claim 18, wherein the friction coefficient is computed using preselected values of the braking speed, the rotor temperature, and the corner energy.
